(19) United States
(12) Patent Application Publication
(10) Pub. No.: US 2025/0030619 A1
(43) Pub. Date: Jan. 23, 2025

(54) SYSTEM AND METHOD FOR DATA ACCESSING

(71) Applicant: 17LIVE Japan Inc., Tokyo (JP)

(72) Inventors: Sheng-Chuan HSU, Taipei City (TW); Xuan-Yu JI, Taipei City (TW)

(21) Appl. No.: 18/427,889

(22) Filed: Jan. 31, 2024

(30) Foreign Application Priority Data
Jul. 21, 2023 (JP) 2023-119044

(51) Int. Cl. H04L 43/0852; H04L 51/04

(52) U.S. Cl. CPC H04L 43/0852; H04L 51/04

(57) ABSTRACT

The present disclosure relates to a system and a method for data accessing. The method includes: obtaining a request from a user of the user terminal; obtaining a type of the request, obtaining request tolerance data of the user; and determining a delay time for transmitting the request to a backend server corresponding to the request according to the type of the request and the request tolerance data of the user.

### CROSS-REFERENCE TO RELATED APPLICATIONS

This application is based on and claims the benefit of priority from Japanese Patent Application Serial No. 2023-119044 (filed on Jul. 21, 2023), the contents of which are hereby incorporated by reference in its entirety.

### TECHNICAL FIELD

The present disclosure relates to data accessing and, more particularly, to data accessing with a server.

### BACKGROUND

Real time interaction on the Internet, such as live streaming service, has become popular in our daily life. There are various platforms or providers providing the service of live streaming, and the competition is fierce. It is important for a platform to provide its users their desired services.

China patent application publication CN114268631A discloses a multi-dimensional reduction of network delay.

### SUMMARY

A method according to one embodiment of the present disclosure is a method for data accessing being executed by one or a plurality of computers, and includes: obtaining a request from a user of the user terminal; obtaining a status data of a backend server corresponding to the request; transmitting the request to the backend server corresponding to the request according to the status data; obtaining a response of the request from the backend server; determining the response to have an error; determining a delay time for a retry of transmitting the request to the backend server according to the status data.

A method according to one embodiment of the present disclosure is a method for data accessing being executed by one or a plurality of computers, and includes: obtaining a request from a user of the user terminal; obtaining a type of the request, obtaining request tolerance data of the user; and determining a delay time for transmitting the request to a backend server corresponding to the request according to the type of the request and the request tolerance data of the user.

A system according to one embodiment of the present disclosure is a system for data accessing that includes one or a plurality of processors, and the one or plurality of computer processors execute a machine-readable instruction to perform: obtaining a request from a user of the user terminal; obtaining a status data of a backend server corresponding to the request; transmitting the request to the backend server corresponding to the request according to the status data; obtaining a response of the request from the backend server; determining the response to have an error; determining a delay time for a retry of transmitting the request to the backend server according to the status data.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 shows a block diagram illustrating functions and configuration of the server 10 and the user terminal 30 according to some embodiments of the present disclosure.

FIG. 8 is a data structure diagram showing an example of the request DB 250.

FIG. 9 is a data structure diagram showing an example of the user tolerance DB 252.

FIG. 10 is a data structure diagram showing an example of the retry DB 254.

FIG. 11 is a data structure diagram showing an example of the status DB 320.

FIG. 12 shows an exemplary flow chart illustrating a method according to some embodiments of the present disclosure.

FIG. 13 shows an exemplary flow chart illustrating a method according to some embodiments of the present disclosure.

FIG. 14 shows an example of generating the user tolerance data according to some embodiments of the present disclosure.

FIG. 15 shows an example of determining the transmission retry timing according to the endpoint status data and the retry number.

FIG. 16 shows an exemplary time sequence according to some embodiments of the present disclosure.

FIG. 17 shows an exemplary time sequence according to some embodiments of the present disclosure.

FIG. 18 shows an exemplary flow of data accessing according to some embodiments of the present disclosure.

FIG. 19 is a block diagram showing an example of a hardware configuration of the information processing device according to some embodiments of the present disclosure.

### DESCRIPTION OF THE EMBODIMENTS

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

Data accessing over the Internet usually involves a user terminal (such as a smartphone, a tablet or a computer) used by a user, an application (or an application software, such as a live streaming application software) that runs on the user terminal, and a server of the application (or an application server) that communicates with the user terminal.

The user may initiate a data request through a user interface of the application, which may involve a clicking, taping, or scrolling action. The request is then transmitted from the user terminal to the server. Subsequently, the server sends a response corresponding to the request to the user terminal, thus completing the data accessing.

The condition of the server (such as loading condition or other health conditions) may determine whether or not the data accessing is successful or not. It is desirable to have an accessing mechanism that can efficiently and dynamically utilize the resource of the server, without overloading the server.

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

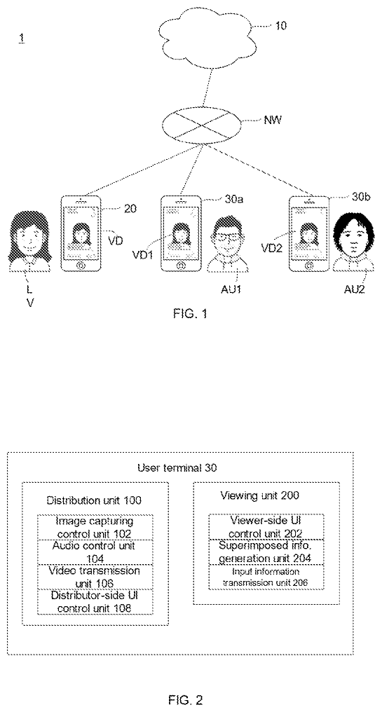

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side U1 control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side U1 control unit 202 to the server 10 over the network NW.

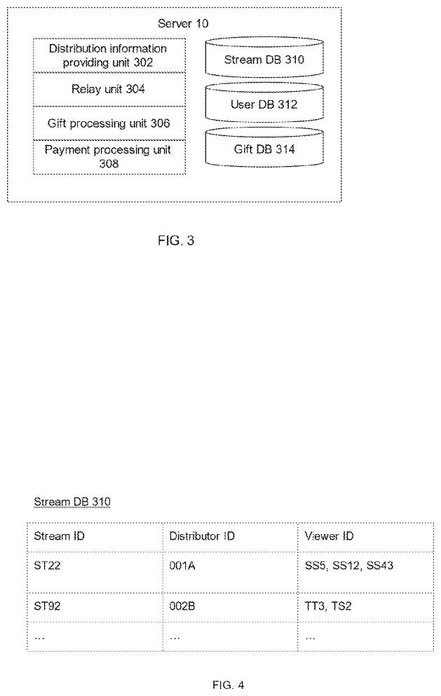

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, and a gift DB 314.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side U1 control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

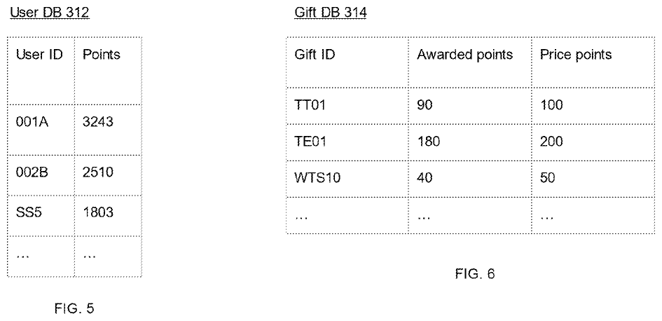

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

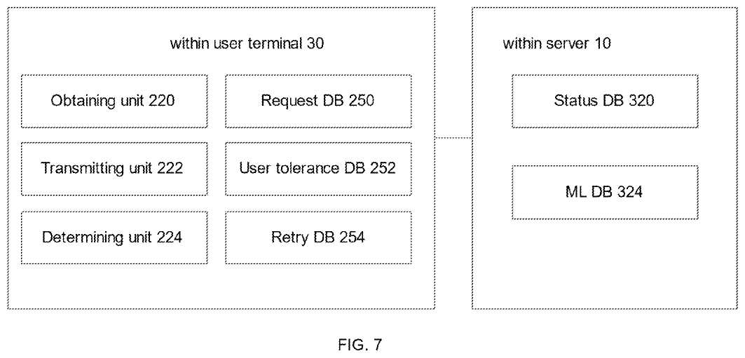

FIG. 7 shows a block diagram illustrating functions and configuration of the server 10 and the user terminal 30 according to some embodiments of the present disclosure.

The user terminal 30 includes an obtaining unit 220, a transmitting unit 222, a determining unit 224, a request DB 250, a user tolerance DB 252, and a retry DB 254. The server 10 includes a status DB 320 and a ML DB 324. In some embodiments, the ML DB 324 could be implemented within the user terminal 30.

The obtaining unit 220 is configured to obtain a request (or API request) from a user of the user terminal 30. The request may be initiated by the user through a user interface of the user terminal 30. The obtaining unit 220 is configured to obtain a status data (or status prediction) of a backend server (or an endpoint of the backend server) corresponding to the request. The backend server could be the server 10. The status data could be obtained from the status DB 320 of the server 10.

The transmitting unit 222 is configured to transmit the request to the backend server (or the endpoint) corresponding to the request according to (or in response to) the status data. For example, the transmitting unit 222 may determine to transmit the request immediately or after a time period according to the health status of the backend server.

The obtaining unit 220 is configured to obtain a response of the request from the backend server.

The determining unit 224 is configured to determine if there is error in the response. If there is error in the response, the determining unit 224 determines a delay time for a retry of transmitting the request to the backend server according to the status data.

In some embodiments, the determining unit 224 determines a total number of retry times of transmitting the request to the backend server according to the status data.

In some embodiments, the delay time is determined according to the status data and a retry number of the retry.

In some embodiments, the determining unit 224 determines if the delay time is longer than an update period of the status data of the backend server (in the status DB 320). If yes, the obtaining unit 220 obtains an updated status data of the backend server, and the determining unit 224 updates the delay time of the retry according to the updated status data.

In some embodiments, the obtaining unit 220 obtains (or detects) a status of the user, and obtains (or detects) a type of the request. The delay time could be determined according to the status data of the endpoint, the status of the user, and/or the type of the request. The status of the user could be stored in the user DB 312 and/or the request DB 250. The type of the request could be stored in the request DB 250.

In some embodiments, the obtaining unit 220 obtains a tolerance data of the user, and obtains a type of the request. The delay time could be determined further according to the tolerance data of the user and the type of the request. The tolerance data could be stored in the user tolerance DB 252.

In some embodiments, the determining unit 224 determines the delay time to be shorter if the user is determined to have a low tolerance regarding the type of the request according to the tolerance data of the user. In some embodiments, the determining unit 224 determines the delay time to be longer if the user is determined to have a high tolerance regarding the type of the request according to the tolerance data of the user.

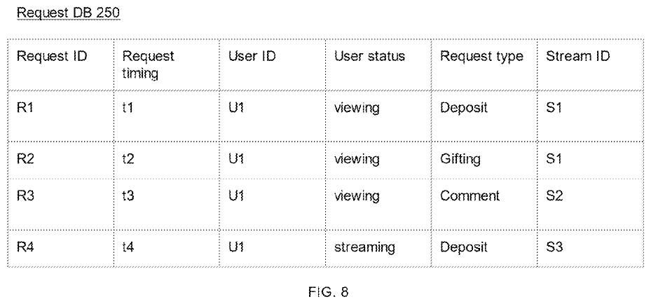

FIG. 8 is a data structure diagram showing an example of the request DB 250.

The request DB 250 stores the request ID, the request timing, the user ID, the user status, the request type, and the stream ID, in association with each other.

The user status is the status of the user when the request is made by the user. For example, the request R1 (to deposit) is made by user U1 when user U1 is a viewer viewing the stream SI. The request R4 (to deposit) is made by user U1 when user U1 is a distributor distributing the stream S3. The request type of “Deposit” could be a request to deposit money or points on the streaming platform. The request type of “Gifting” could be a request to send a gift in a chat room (or in a stream) of the streaming platform. The request type of “Comment” could be a request to post a comment in a chat room (or in a stream) of the streaming platform. Some request types, such as “Deposit”, could be performed by the user whether when the user is viewing a stream or is distributing a stream. In some embodiments, a correct (or successful) response to a request could be an indication of completing the task or a display of the corresponding effect.

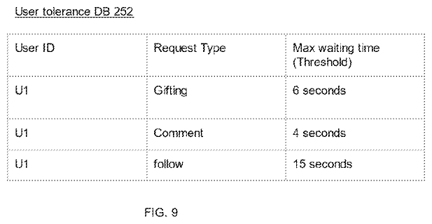

FIG. 9 is a data structure diagram showing an example of the user tolerance DB 252. The user tolerance DB 252 stores the user ID, the request type, and the maximum waiting time (or delay threshold time), in association with each other.

The maximum waiting time is the maximum time length for the user to be able to tolerate to complete the corresponding request type. For example, user U1 can not tolerate a wait time for longer than 6 seconds for sending a gift. User U1 can wait 15 seconds for a “follow” request to be completed. A “follow” request is a request to follow a distributor performed in a stream of the distributor. The tolerance data could be generated by a machine learning algorithm in the ML DB 324.

In some embodiments, the tolerance data of each user could be transmitted to and stored in the server 10 for overall response allocation. For example, the server 10 (or an allocating unit within the server 10) may allocate the timings to reply responses to requests from different users according to their respective tolerance data. For example, under high loading conditions of the server 10, a request R1 from user U1 with a low tolerance degree may be replied earlier than a request R2 from user U2 with a high tolerance degree. The mechanism can optimize the general satisfaction for users and can improve the overall revenue for the platform.

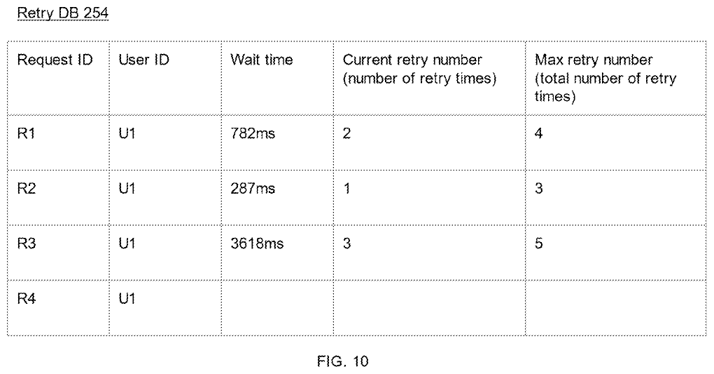

FIG. 10 is a data structure diagram showing an example of the retry DB 254. The retry DB 254 stores the retry data (or retry plan, or retry schedule) for requests. The retry DB 254 stores the request ID, the user ID, the wait time (or delay time) of the request, the current retry number (current number of retry times), and the maximum retry number (total number of retry times), in association with each other.

The retry data is determined by the determining unit 224. In some embodiments, the retry data of a request is determined by the status data of the corresponding endpoint, the status of the user, the type of the request, and/or the tolerance data of the user.

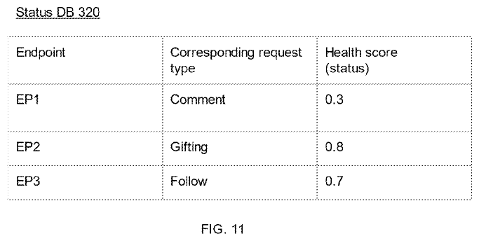

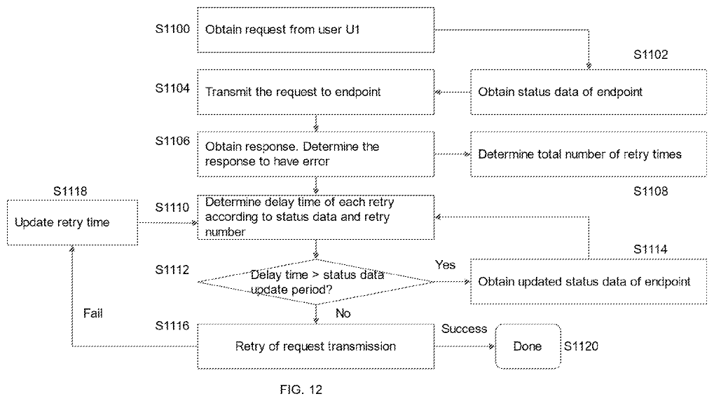

FIG. 11 is a data structure diagram showing an example of the status DB 320. The status DB 320 stores the endpoint (or API endpoint), the corresponding request type, and the health score (or health status), in association with each other.

The health score could be calculated according to parameters of the endpoint. The calculation could be determined according to actual practice or the focus of the operator of the platform. The calculation could be performed by a machine learning algorithm in the ML DB 324. A normalization could be performed in the calculation. Some examples of the parameters of the endpoint are: historical API response time, historical response error rate, historical throughput, historical latency, CPU usage rate of the server hosting the endpoint, memory usage rate of the server hosting the endpoint, and number of concurrent connections handled by the server hosting the endpoint.

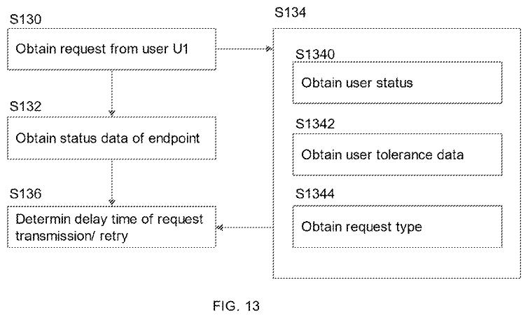

FIG. 12 shows an exemplary flow chart illustrating a method according to some embodiments of the present disclosure.

At step S1100, the obtaining unit 220 obtains a request from user U1, through a UI of the user terminal, for example.

At step S1102, the obtaining unit 220 obtains the status data of the endpoint corresponding to the request from the status DB 320.

At step S1104, the transmitting unit 222 transmits the request to the endpoint. Before transmitting the request, the endpoint may be determined (by the determining unit 224 or by the transmitting unit 222) to be healthy enough according to the status data.

At step S1106, the obtaining unit 220 obtains the response. The determining unit 224 determines the response to have an error.

At step S1108, the determining unit 224 determines a total number of retry times for the request transmission according to the status data.

At step S1110, the determining unit 224 determines (or updates) the delay time of each (or the upcoming one) transmission retry according to the status data (or updated status data) and/or the retry number of the retry.

At step S1112, the determining unit 224 determines whether the delay time (determined in step S1110) is longer than a status update time period of the status data. If yes, the flow goes to step S1114. If not, the flow goes to step S1116. In some embodiments, at step S1112, the determining unit 224 determines whether or not the status of the endpoint has been updated since the last determination of the delay time.

At step S1114, the obtaining unit 220 obtains the updated status data of the endpoint. Subsequently, the flow goes back to step S1110 wherein the determining unit 224 updates the delay time of each (or the upcoming one) transmission retry according to the updated status data.

At step S1116, the transmitting unit 222 performs the retry of the request transmission. The obtaining unit 220 obtains the response. The determining unit 224 determines whether the response is successful or not (with error). If successful, the flow goes to step S1120 wherein the data accessing completes. If not, the flow goes to step S1118.

At step S1118, the number of retry times is updated, by a counter within the user terminal, for example. The flow then goes back to step S1110, wherein the determining unit 224 updates the delay time of each (or the upcoming one) transmission retry according to the status data and the updated retry number of the retry.

FIG. 13 shows an exemplary flow chart illustrating a method according to some embodiments of the present disclosure.

At step S130, the obtaining unit 220 obtains the request from user U1.

At step S132, the obtaining unit 220 obtains the status data of the endpoint corresponding to the request from the status DB 320.

Step S134 includes three steps: S1340, S1342 and S1344.

At step S1340, the obtaining unit 220 obtains the user status data of user U1, from the request DB 250, for example.

At step S1342, the obtaining unit 220 obtains the user tolerance data of user U1, from the user tolerance DB 252, for example.

At step S1344, the obtaining unit 220 obtains or detects the request type of the request.

At step S136, the determining unit 224 determines the delay time of the request transmission (first time or retry) according to the status data of the endpoint, the user status, the user tolerance data, and/or the request type.

FIG. 14 shows an example of generating the user tolerance data according to some embodiments of the present disclosure.

The feature data input into the ML DB 324 may include request type sequence for each user, the waiting time sequence for each user, the exit behavior data (such as the time sequence of leaving the streaming platform or leaving a stream chat room) for each user, the feedback data (such as complaint data) from each user, among others. The ML DB 324 then generates the user tolerance data that indicates the tolerance (or threshold value) for each user with respect to different request types. The user tolerance data may be similar to the example shown in FIG. 9. The tolerance could be referred to as request tolerance data for the user.

For example, the ML DB 324 may perform correlation analysis on the feature data to determine which request type's waiting time is correlated with the exit action (and/or the complaint action) the most, and to find out the related threshold value, for each user. The threshold value could be the maximum waiting time the user can wait until he or she leaves the chat room (or the platform), and therefore can be set as a maximum value for the delay time. Different users may have different tolerance degrees on different request types. The present disclosure provides a customized mechanism for determining the delay time of request transmission for each user.

In some embodiments, the determining unit 222 determines the total number of retry times to be more when the status data of the endpoint indicates a better condition for the endpoint. In some embodiments, the determining unit 222 determines the total number of retry times to be less when the status data of the endpoint indicates a worse condition for the endpoint. A better condition could mean more available processing capacity of the endpoint (or server) to handle the request. A worse condition could mean higher burden for the endpoint and more retry times may lead to higher crash risk.

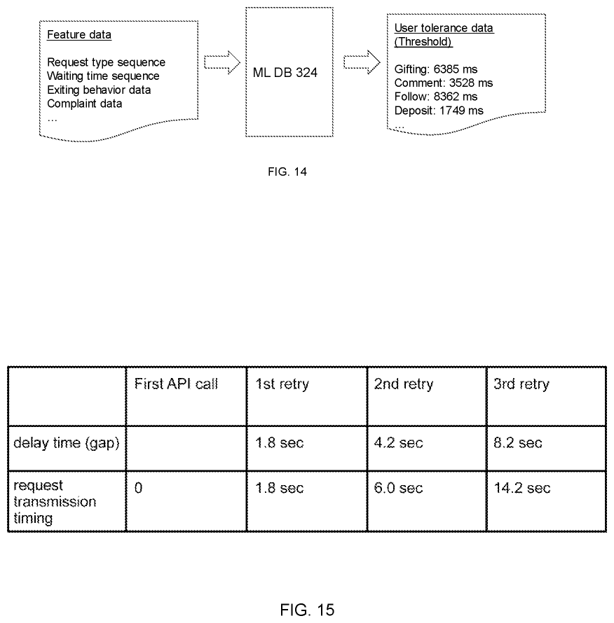

FIG. 15 shows an example of determining the transmission retry timing according to the endpoint status data and the retry number.

In this embodiment, the delay time for a retry is determined according to: delay time=k(n*n)+y. k is the endpoint health score (status data). n is the fail time of API call. y is the time needed to send a request and to receive the response. The numbers in FIG. 15 are calculated under the assumption [health score=0.8, y=1 sec]. The health score k is normalized and is between 0 and 1. In this embodiment, a greater score indicates a worse condition for the endpoint. The delay time increases with the health score because in a worse condition the server needs more time to process and to balance the request flow. The delay time increases with the retry number (number of retry times), because more times of retry failure means a worse condition for the server, and the server needs longer time to recover or to process. The increase is sharper than linear manner and could achieve a more efficient relief of the server.

In some embodiments, the determining unit 224 determines the delay time of a request transmission or retry based on the potential revenue contribution of the request. The potential revenue contribution could be related to the user status and the request type. For example, a request type of “deposit” from a user when the user is viewing a stream may be given a shorter transmission (or retry) delay time (or, higher transmission priority) compared to a request type of “deposit” from a user when the user is distributing a stream. When the user is viewing a stream, a “deposit” action may lead to a subsequent “gifting” action, which leads to higher contribution on the platform. In some embodiments, a request type of “poking” from a user when the user is distributing a stream may be given a shorter transmission (or retry) delay time (or, higher transmission priority) compared to a request type of “poking” from a user when the user is viewing a stream. A distributor may use poking action to remind a viewer to interact more or to contribute more in the chat room.

In some embodiments, historical data regarding different request types, different user status, and the resulting contribution data can be utilized by the ML DB 324 to determine the correlation between the three, and to determine the delay time (or priority) of the request transmission (or transmission retry).

In some embodiments, calculation of potential contribution may depend on the dependencies or relationships between different request types. For example, a request to obtain the gift list from a viewer may lead to a subsequent gifting request, therefore the request to obtain the gift list could be deemed to have high potential contribution. For example, a request to obtain a viewer list from a distributor may lead to subsequent poking request, which may enhance the viewers to gift more, therefore the request to obtain the viewer list may be deemed to have high potential contribution. In some embodiments, the obtaining unit 220 obtains dependency data between different request types (from a request DB within the server 10, for example), and the determining unit 224 determines the delay time (or priority) of transmitting (or retransmitting) the request accordingly. For example, a request with a higher potential contribution may be given a shorter delay time (or higher priority).

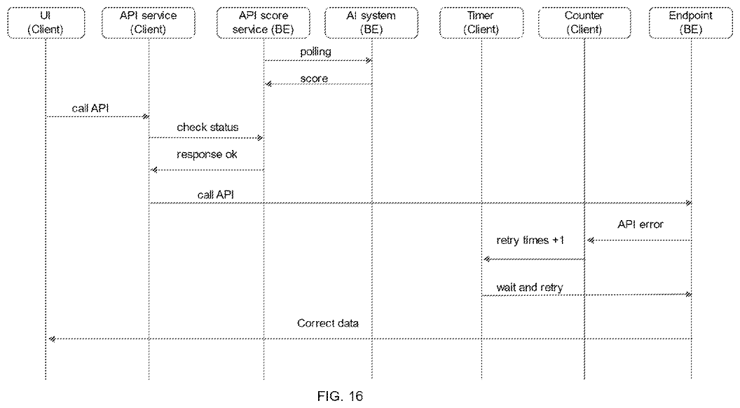

FIG. 16 shows an exemplary time sequence according to some embodiments of the present disclosure.

The API score service (or status DB) on the backend (BE) side performs a polling process towards the AI system on the BE side to get scores of endpoints. The AI system calculates and/or monitors the scores of endpoints. The UI on the client side sends an API request to an API service on the client side. The API service checks the status of the corresponding endpoint with the API score service. If the status is acceptable, the API service sends the API request to the corresponding endpoint on the BE side. If there is error in the response received at the client side, a counter on the client side would increase one retry time, and a timer on the client side would count the delay time to perform a transmission retry. The delay time could be calculated by a determining unit according to the methods described above. After the retry, correct data is received at the client side and is presented to the U1.

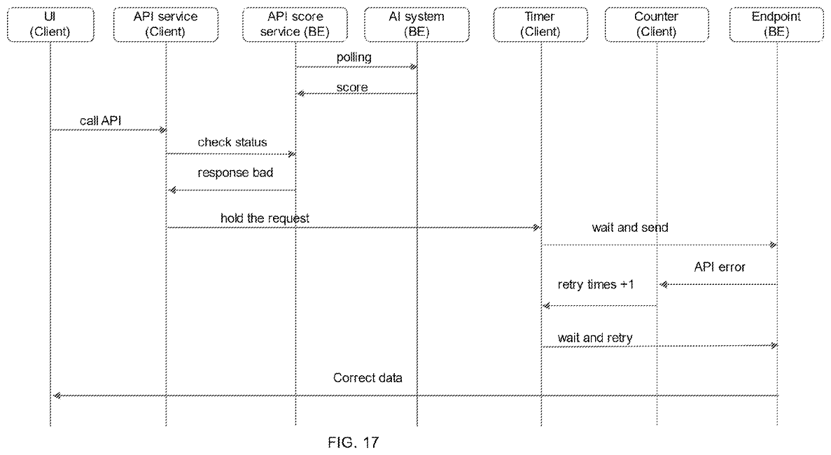

FIG. 17 shows an exemplary time sequence according to some embodiments of the present disclosure.

The API score service (or status DB) on the backend (BE) side performs a polling process towards the AI system on the BE side to get scores of endpoints. The AI system calculates and/or monitors the scores of endpoints. The UI on the client side sends an API request to an API service on the client side. The API service checks the status of the corresponding endpoint with the API score service. The response shows the endpoint is not in a good condition to receive a request. The client holds the request. The timer waits for a delay time and sends out the request to the endpoint. The delay time could be calculated by a determining unit according to the methods described above. If there is error in the response received at the client side, a counter on the client side would increase one retry time, and the timer would count the delay time to perform a transmission retry. The delay time could be calculated by the determining unit according to the methods described above. After the retry, correct data is received at the client side and is presented to the U1.

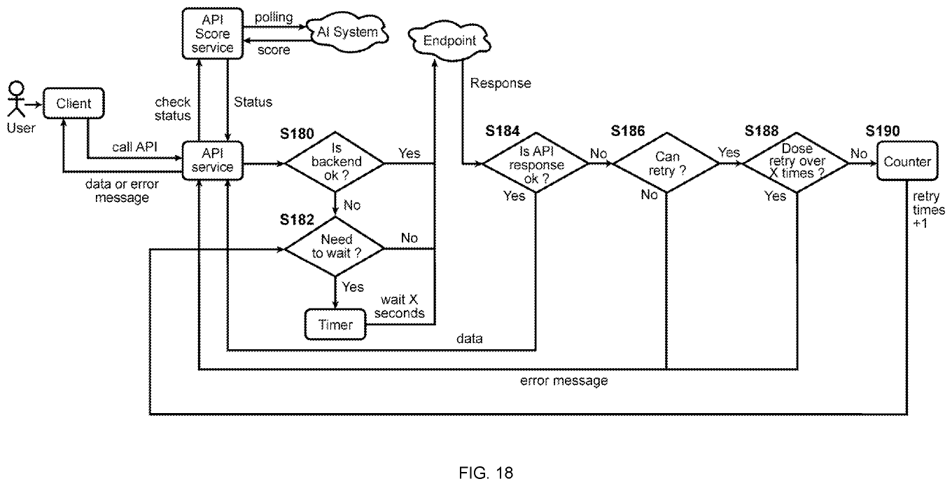

FIG. 18 shows an exemplary flow of data accessing according to some embodiments of the present disclosure. Some processes are similar to the descriptions in FIG. 16 and FIG. 17.

The client calls an API request to the API service. The API service checks the status data of the endpoint corresponding to the API request with the API score service.

At step S180, the determining unit 224 determines whether the endpoint is in good condition or not according to the status data. If yes, the request is sent to the endpoint. If not, the flow goes to step S182.

At step S182, the determining unit 224 determines whether or not to wait a delay time to send the request to the endpoint according to the severity condition of the endpoint. If the condition is not too severe and there is no need to wait, the request is sent to the endpoint. If the condition is severe, a timer will be used to count the delay time before sending the request to the endpoint. The delay time could be determined according to the methods described above.

At step S184, the determining unit 224 determines if the response from the endpoint is correct or not. If the response is correct, the correct data is sent to the API service, which then transmits the data to the client. If the response contains error, the flow goes to step S186.

At step S186, the determining unit 224 determines if a retry can be applied to the API request transmission. If yes, the flow goes to step S188. If not, an error message is sent to the API service, which will then pass the error message to the client.

At step S188, the determining unit 224 determines if the retry time has been over a determined maximum retry time number (which could be determined according to the methods described above). If not, the flow goes to step S190. If yes, an error message is sent to the API service, which will then pass the error message to the client.

At step S190, a counter increases the retry time by one and the flow goes back to step S182, wherein an updated status data of the endpoint may be used to determine the waiting process for the request retry transmission.

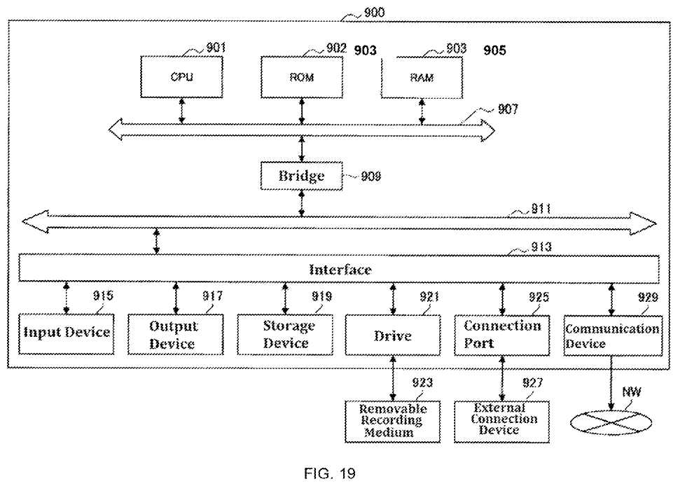

Referring to FIG. 19, the hardware configuration of the information processing device will be now described. FIG. 19 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system I in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### DESCRIPTION OF REFERENCE NUMERALS

1 communication system
10 server
20 user terminal
30, 30a, 30b user terminal
LV distributor
AU1, AU2 viewer
VD, VD1, VD2 video image
NW network
30 user terminal
100 distribution unit
102 image capturing control unit
104 audio control unit
106 video transmission unit
108 distributor-side UI control unit
200 viewing unit
202 viewer-side UI control unit
204 superimposed information generation unit
206 input information transmission unit
302 distribution information providing unit
304 relay unit
306 gift processing unit
308 payment processing unit
310 stream DB
312 user DB
314 gift DB
220 obtaining unit
222 transmitting unit
224 determining unit
250 request DB
252 user tolerance DB
254 retry DB
320 status DB
324 ML DB
S1100, S1102, S1104, S1106, S1108, S1110, S1112, S1114, S1116, S1118,
S1120 step
S130, S132, S134, S136, S1340, S1342, S1344
S180, S182, S184, S186 S188, S190 step
step
900 information processing device
901 CPU
903 ROM
905 RAM
907 host bus
909 bridge
911 external bus
913 interface
915 input device
917 output device
919 storage device
921 drive
923 removable recording medium
925 connection port
927 external connection device
929 communication device

What is claimed is:

1. A method for data accessing, executed by a user terminal, comprising:
obtaining a request from a user of the user terminal;
obtaining a status data of a backend server corresponding to the request;
transmitting the request to the backend server corresponding to the request according to the status data;
obtaining a response of the request from the backend server;
determining the response to have an error;
determining a delay time for a retry of transmitting the request to the backend server according to the status data.

2. The method according to claim 1, further comprising:
determining a total number of retry times of transmitting the request to the backend server according to the status data.

3. The method according to claim 1, wherein the delay time is determined according to the status data and a retry number of the retry.

4. The method according to claim 1, further comprising:
determining the delay time to be longer than an update period of the status data;
obtaining an updated status data; and
updating the delay time of the retry according to the updated status data.

5. The method according to claim 1, further comprising:
obtaining a status of the user; and
obtaining a type of the request,
wherein the delay time is determined according to the status data, the status of the user, and the type of the request.

6. The method according to claim 1, further comprising:
obtaining tolerance data of the user; and
obtaining a type of the request,
wherein the delay time is determined further according to the tolerance data of the user and the type of the request.

7. The method according to claim 6, further comprising:
determining the delay time to be shorter if the user is determined to have a low tolerance level regarding the type of the request according to the tolerance data of the user; and
determining the delay time to be longer if the user is determined to have a high tolerance level regarding the type of the request according to the tolerance data of the user.

8. The method according to claim 7, wherein the request is associated with an action of the user in a live streaming chat room, and the tolerance data indicates the dependency of different tolerance levels of the user on different request types.

9. A method for data accessing, executed by a user terminal, comprising:
obtaining a request from a user of the user terminal;
obtaining a type of the request,
obtaining request tolerance data of the user; and
determining a delay time for transmitting the request to a backend server corresponding to the request according to the type of the request and the request tolerance data of the user.

10. The method according to claim 9, further comprising:
obtaining a status of the user,
wherein the delay time is determined according to the status of the user, the type of the request, and the request tolerance data of the user.

11. A system for distributor analysis, comprising one or a plurality of processors, wherein the one or plurality of processors execute a machine-readable instruction to perform:
obtaining a request from a user of the user terminal;
obtaining a status data of a backend server corresponding to the request;
transmitting the request to the backend server corresponding to the request according to the status data;
obtaining a response of the request from the backend server;
determining the response to have an error;
determining a delay time for a retry of transmitting the request to the backend server according to the status data.
